(19) United States
(12) Patent Application Publication
(10) Pub. No.: US 2024/0385072 A1
(43) Pub. Date: Nov. 21, 2024

(54) A METHOD FOR PICKING UP SIGNALS FROM AN IMPACT VIBRATION SENSOR

(71) Applicant: SUZHOU SUSHI TESTING GROUP CO., LTD., Suzhou, Jiangsu (CN)

(72) Inventor: Jiuzhao SHENG, Suzhou (CN)

(73) Assignee: SUZHOU SUSHI TESTING GROUP CO., LTD., Suzhou, Jiangsu (CN)

(21) Appl. No.: 18/574,641

(22) PCT Filed: Nov. 23, 2021
(86) PCT No.: PCT/CN2021/132459

§ 371 Date: Dec. 27, 2023

(30) Foreign Application Priority Data
Jul. 22, 2021 (CN) 202110828847.9

(51) Int. Cl. G01M 7/02

(52) U.S. Cl. CPC G01M 7/025

(57) ABSTRACT

The present invention relates to a method for picking up signals from an impact vibration sensor, which comprises: sampling impact vibration signal; averaging and identifying a maximum value of the impact vibration signal; determining whether the maximum value is located in the middle of the sampling data; if yes, determining whether sampling data on both sides of the maximum value exhibit monotonic increase or monotonic decrease and values are approximately the same, and determining appropriate sampling data is collected if three requirements are all met; if not, adjusting sampling data until requirements are met. Processing signals collected by the impact vibration sensor in the time domain allows for obtaining impact vibration signals that meet requirements. The accuracy of the signals is high, enabling real-time signal acquisition. Additionally, corroborating the results of time-domain processing through frequency-domain analysis enhances the reliability and accuracy of the collected signals.

### TECHNICAL FIELD

The present invention relates to the field of vibration test technology, and more particularly to a method for picking up signals from an impact vibration sensor.

### BACKGROUND ART

As China becomes a major manufacturing country, the reliability of products is increasingly a focus of global attention. Quality products generally undergo a series of rigorous tests before market launch. such as sand and dust tests, salt spray tests. vibration tests. impact tests. and temperature tests, to verify whether the product design meets the requirements.

For impact test equipment, the most critical parameter in an impact test is the impact strength. To accurately set the impact strength, it is necessary to precisely pick up the signals generated by the impact vibration sensor. Currently, the pickup of impact vibration signals is inaccurate due to inherent disturbances and external environmental noise, requiring multiple pickups and judgments based on the results, significantly affecting the quality and efficiency of the tests.

Therefore, there is a need for a technology that can accurately pick up impact vibration signals under external disturbances.

### SUMMARY OF THE INVENTION

To solve the above problem, the present invention provides a method for picking up signals from an impact vibration sensor, capable of accurately and in real-time picking up impact vibration signals despite internal and external disturbances.

The technical solution of the present invention adopted to solve the above technical problem is a method for picking up signals from an impact vibration sensor, which comprises:
step S1, sampling vibration frequency through the impact vibration sensor to obtain several sampling data, and according to a predetermined response period, allocating the sampling data to several response periods, and selecting a response period and proceeding to step 2;
step S2, averaging the sampling data within the response period and identifying a maximum value among the sampling data;
step S3, determining whether the maximum value is located in the middle of the sampling data's sampling time. proceeding to step S6 if the maximum value is located in the middle of the sampling data's sampling time, and proceeding to step S4 if the maximum value is not located in the middle of the sampling data's sampling time;
step S4, determining whether the sampling data meets quantity and trend requirements, proceeding to step S5 if the sampling data meets the quantity and trend requirements, and selecting sampling data of a next response period and returning to step S2 if the sampling data does not meet the quantity and trend requirements;
step S5, starting with an effective value of a current sampling data, moving the position of the response period, re-obtaining a complete response period, and returning to step S2; and
step S6, determining whether the following three conditions are all met within the response period: sampling data on the left side of the maximum value increases monotonically, sampling data on the right side of the maximum value decreases monotonically, and values of monotonic increase and monotonic decrease are the same; determining the sampling data picked up within the response period meet the requirements if the three conditions are all met, and selecting sampling data of a next response period and returning to step S2 if the three conditions are not all met.

In a further specific embodiment, the method for determining whether the sampling data meets the quantity and trend requirements in step S4 comprises:
step S41, searching for and counting a number of sampling data on the left side of the maximum value that are above an average value and determining whether the count of the sampling data on the left side of the maximum value that are above the average value is less than N, proceeding to step S42 if the count is less than N, and proceeding to step S43 if the count is not less than N;
step S42, searching for and counting a number of sampling data on the right side of the maximum value that are above an average value and determining whether the count of the data on the right side of the maximum value that are above the average value is less than N, selecting the sampling data of a next response period and returning to step S2 if the count is less than N, and proceeding to step S44 if the count is not less than N;
step S43, dividing the sampling data on the left side of the maximum value into k parts, adding up the sampling data on the left side of the maximum value in each part to get k sums, and determining whether the k sums increase monotonically; proceeding to step S5 if the k sums increase monotonically, and selecting sampling data of a next response period and returning to step S2 if the k sums do not increase monotonically; and
step S44, dividing the sampling data on the right side of the maximum value into k parts, adding up the sampling data on the right side of the maximum value in each part to get k sums, and determining whether the k sums decrease monotonically; proceeding to step S5 if the k sums decrease monotonically, and selecting sampling data a next response period and returning to step S2 if the k sums do not decrease monotonically.

In a further specific embodiment, N in steps S41 and S42 is 100.

In a further specific embodiment, the method for determining whether sampling data on the left side of the maximum value increases monotonically in step S6 comprises: dividing sampling data within the response period into q parts, adding up the sampling data in each part to obtain q sums, and selecting several sums on the left side of the maximum value for determining.

In a further specific embodiment, the method for determining whether sampling data on the right side of the maximum value decreases monotonically in step S6 comprises: dividing sampling data within that response period into q parts, adding up the sampling data in each part to obtain q sums, and selecting several sums on the right side of the maximum value for determining.

In a further specific embodiment, after completing picking up of impact vibration signal, sampling data are processed using a frequency-domain processing method to determine whether the impact vibration signal is detected.

In a further specific embodiment, a frequency-domain processing method comprises:
step S71, performing FFT calculations on all sampling data to obtain several frequency data;
step S72, performing square-law detection on the several frequency data, forming several complex number data with every four frequency data;
step S73, calculating a first threshold by converting the complex number data into real number data, summing up and calculating an average value, and calculating a mean square deviation based on the real number data and the average value; wherein
the first threshold is represented as C^{P}=k·C^{σ}, where k=2;
step S74, comparing all frequency data with the first threshold, selecting frequency data below the first threshold to form a second set of frequency data, and calculating a second threshold according to steps S72-S73;
step S75, comparing all frequency data with the second threshold and counting a number of frequency data above the second threshold;
step S76, determining whether the count of frequency data above the second threshold is more than 10% of total number of all frequency data, indicating that impact vibration signal is detected if the count is more than 10% of the total number of all frequency data, and indicating that impact vibration signal is not detected if the count is not more than 10% of the total number of all frequency data.

In a further specific embodiment, complex number data in step S72 comprises a real part and an imaginary part, wherein
the real part is represented as

$${B}_{j}^{cos} = \frac{{A}_{( 4 j )} - {A}_{( 4 j + 2 )}}{2} ;$$

and
the imaginary part is represented as

$${B}_{j}^{sin} = \frac{{A}_{( 4 j + 1 )} - {A}_{( 4 j + 3 )}}{2} ;$$

where A₍ⱼ₎ represents frequency data, and Bⱼ represents complex number data.

In a further specific embodiment. a formula for converting complex number data into real number data is as follows:

$${C}_{j} = \sqrt{{( {B}_{j}^{cos} )}^{2} + {( {B}_{j}^{sin} )}^{2}} .$$

The beneficial effects of the present invention are: using the time-domain method to process the signals collected by the impact vibration sensor, obtaining impact vibration signals that meet the requirements with high accuracy, and achieving real-time signal collection. Meanwhile, further verification of the time-domain processing results is conducted using the frequency-domain method, increasing the reliability and accuracy of the collected signals.

### BRIEF DESCRIPTION OF THE DRAWINGS

FIG. 1 is a schematic flow diagram of the time-domain processing in the present invention;

FIG. 2 is a schematic flow diagram of the process of determining the quantity and trend of the sampling data in the present invention;

FIG. 3 is a schematic flow diagram of the frequency-domain processing in the present invention.

### DETAILED DESCRIPTION

The following, in conjunction with the accompanying drawings, provides a clear and comprehensive description of the technical solution of the present invention. It is evident that the described embodiments are part of the embodiments of the present invention. not the entirety. Based on the embodiments in the present invention. all other embodiments that ordinary skilled artisans may obtain without creative labor are within the scope of protection of the present invention.

In the description of the present invention, it should be noted that terms such as “center”, “upper”, “lower”, “left”, “right”, “vertical”, “horizontal”, “inner”, “outer” etc., indicating orientation or positional relationships, are based on the orientation or positional relationships shown in the drawings. They are used for the convenience of describing the present invention and simplifying the description, rather than indicating or implying that the device or component referred to must have a specific orientation, be constructed and operated in a specific orientation, and therefore should not be construed as limiting the present invention. In addition, terms such as “first”, “second”, “third” are used for descriptive purposes only and should not be construed as indicating or implying relative importance.

In the description of the present invention, it should be noted that unless otherwise explicitly specified and limited, terms such as “installation”, “connection”, “linkage” should be broadly interpreted. For example, it can be a fixed connection or a detachable connection, mechanical or electrical connection, direct or indirect connection through an intermediate medium, or internal communication within two components. For those skilled in the art. the specific meanings of these terms in the present invention can be understood according to specific situations. In addition, the technical features involved in different embodiments of the present invention described below can be combined with each other as long as they do not conflict.

The response time for impact vibration ranges from 3 to 50 milliseconds. The highest frequency response of impact vibration does not exceed 10 k and varies according to changes in the shock table body and impact strength, with a predominance of low frequencies. Based on the principle of FFT (Fast Fourier Transform), the higher the sampling frequency, the higher the frequency resolution. Taking a frequency response of 10 k as an example, the sampling frequency should not be less than 20 k to accurately reflect the true signal spectrum information. If the A/D (Analog-to-Digital) chip has a sampling frequency of 100 k and a sampling width of 16 bits, with a sampling time of 10 ms, the number of samples taken within the impact vibration response time is 1000, resulting in 2000 bytes of data. Assuming the data storage depth is three times the response time, 6000 bytes of memory need to be allocated. With a time window set to 10 milliseconds, the entire memory data corresponds to three impact response periods.

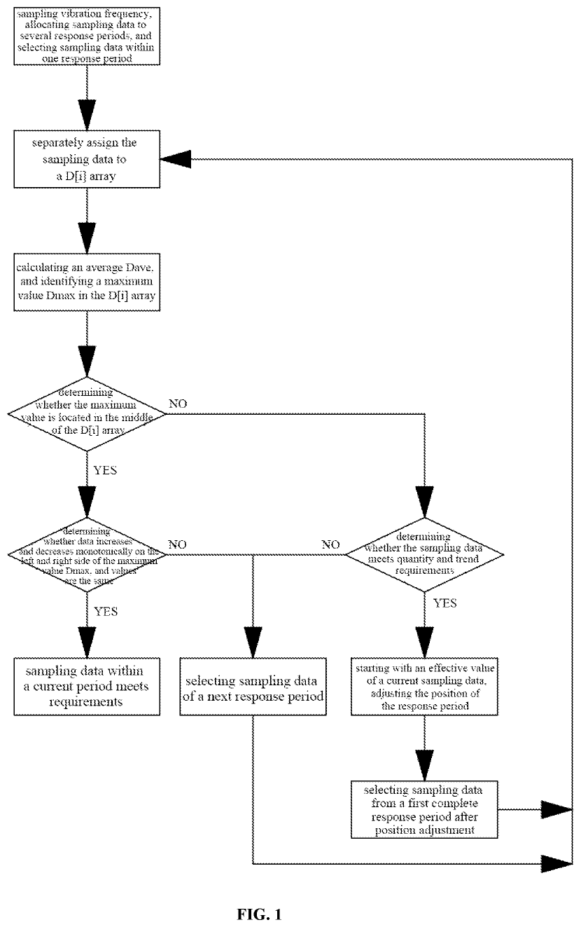

A method for picking up signals from an impact vibration sensor is shown in FIG. 1. The method for picking up signals from an impact vibration sensor comprises:
step S1, sampling vibration frequency through the impact vibration sensor to obtain several sampling data, and according to a predetermined response period, allocating the sampling data to several response periods, and selecting one response period. During software processing, separately assign the sampling data within the response periods to a D[i] array. Proceed to step S2.

Step S2, averaging the sampling data within the chosen response period, i.e., the D[i] array, to calculate an average Dₐᵥₑ, and simultaneously identifying a maximum value Dmax in the D[i] array.

Step S3, determining whether the maximum value is located in the middle of the sampling data's sampling time, meaning a number of sampling data on the left side of Dmax is equal to a number of sampling data on the right side of Dmax; indicating that the sampling data essentially meets requirements and proceeding to step S6 if the maximum value is located in the middle of the sampling data's sampling time; and indicating that the sampling data does not meet requirements, needs adjustment, and proceeding to step S4 if the maximum value is not located in the middle of the sampling data's sampling time.

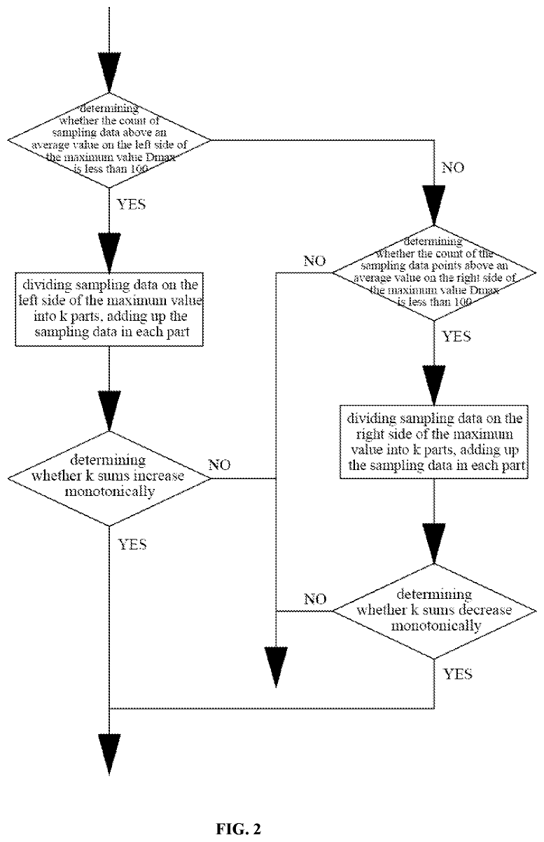

Step S4, determining whether the sampling data meets quantity and trend requirements, as illustrated in FIG. 2:
step S41, searching for and counting a number of sampling data on the left side of the maximum value Dmax that are above an average value Dave and determining whether the count of the sampling data on the left side of the maximum value that are above the average value is less than N (e.g., N=100); indicating that the sampling data on the left side of the maximum value Dmax does not meet requirements and proceeding to step S42 to determine sampling data on the right side of maximum value Dmax if the count of the sampling data on the left side of the maximum value that are above the average value is less than N; and indicating that the sampling data on the left side of the maximum value Dmax meets requirements and proceeding to step S43 to process the sampling data on the left side of maximum value Dmax if the count of the sampling data on the left side of the maximum value that are above the average value is not less than N;
step S42, searching for and counting a number of sampling data on the right side of the maximum value Dmax that are above an average value Dave and determining whether the count of the sampling data on the right side of the maximum value that are above the average value is less than N (e.g., N=100); indicating that the sampling data on the right side of the maximum value Dmax does not meet requirements, selecting sampling data of a next response period, reassigning the sampling data of the next response period to the D[i] array and returning to step S2 to restart an operation if the count of sampling data on the right side of the maximum value that are above the average value is less than N; and indicating that the sampling data on the right side of the maximum value Dmax meets requirements and proceeding to step S44 to process the sampling data on the right side of the maximum value Dmax if the count of sampling data on the right side of the maximum value that are above the average value is not less than N;
step S43, processing the sampling data on the left side of the maximum value Dmax at this point by dividing it into k parts, adding up the sampling data on the left side of the maximum value in each part to get k sums, and determining whether the k sums increase monotonically; indicating that the sampling data on the left side of the maximum value Dmax meets requirements and proceeding to step S5 for further processing if the k sums increase monotonically; and indicating that the sampling data on the left side of the maximum value Dmax does not meet requirements, selecting sampling data of a next response period, reassigning the sampling data of the next response period to the D[i] array and returning to step S2 to restart an operation if the k sums do not increase monotonically;
step S44, processing the sampling data on the right side of the maximum value Dmax at this point by dividing it into k parts, adding up the sampling data on the right side of the maximum value in each part to get k sums, and determining whether the k sums decrease monotonically; indicating that the sampling data on the right side of the maximum value Dmax meets requirements and proceeding to step S5 for further processing if the k sums decrease monotonically; and indicating that the sampling data on the right side of the maximum value Dmax does not meet requirements, selecting sampling data of a next response period, reassigning the sampling data of the next response period to the D[i] array and returning to step S2 to restart an operation if the k sums do not decrease monotonically.

Step S5, adjusting the position of the response period at this point by starting with an effective value of a current sampling data (either sampling data on the left side of the maximum value Dmax or sampling data on the right side of the maximum value Dmax), moving the position of the response period, re-obtaining a set of complete response periods, selecting sampling data from a first complete response period after position adjustment, reassigning the sampling data from the first complete response period to the D[i] array, and returning to step S2 to restart the operation.

Step S6, determining whether the following three conditions are all met within the response period: sampling data on the left side of the maximum value Dmax increases monotonically, sampling data on the right side of the maximum value Dmax decreases monotonically, and values of monotonic increase and monotonic decrease are the same;

Initially, dividing sampling data within the response period into q parts and obtaining q sums by adding up the sampling data in each part. As maximum value Dmax is located in the middle of the D[i] array, the count of sums of sampling data on the left side of maximum value Dmax is equivalent to the count of sums of sampling data on the right side of maximum value Dmax;

Subsequently. selecting all sums on the left side of maximum value Dmax and determining whether the sums on the left side of maximum value Dmax exhibit monotonic increase based on the order of sampling time;

Subsequently, selecting all sums on the right side of maximum value Dmax and determining whether the sums on the right side of maximum value Dmax exhibit monotonic decrease based on the order of sampling time;

Finally, comparing the value of monotonically increasing sums on the left side of maximum value Dmax and the value of monotonically decreasing sums on the right side of maximum value Dmax. If the difference between the value of monotonic increase and the value of monotonic decrease is within 5%, it is considered to meet requirements;

If all three of the conditions are met, it indicates that the sampling data are accurate and can be used. If any of the conditions are not met, it indicates that the sampled data are inaccurate. In this case, sampling data of a next response period is selected and reassigned to the D[i] array, and return to step S2 to restart an operation.

The aforementioned method is a time-domain approach to obtain impact vibration signals. To ensure the accuracy of the picked-up impact vibration signals, after completing the above steps, a frequency-domain processing method is used to process sampling data and determine whether impact vibration signal is detected, thereby corroborating the accuracy of the impact vibration signal.

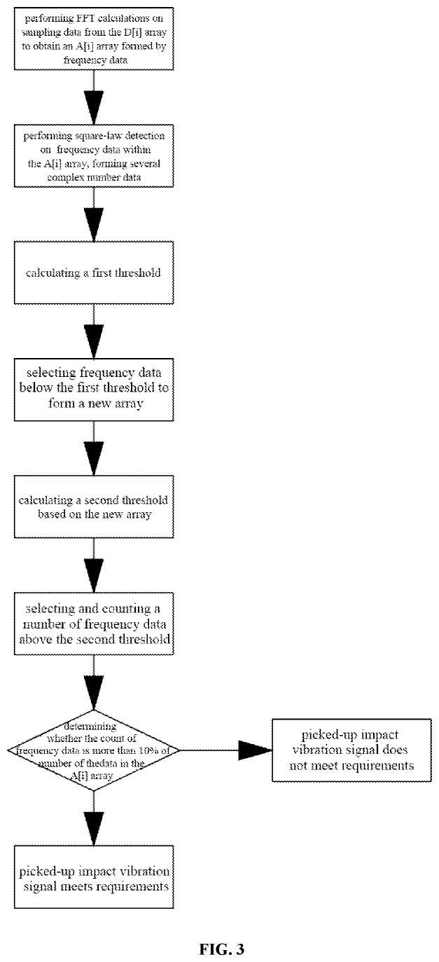

A frequency-domain processing method, as illustrated in FIG. 3, comprises:
Step S71, performing FFT calculations on all sampling data within a current period from the D[i] array to obtain several frequency data, forming an A[i] array, wherein the number of frequency data within the A[i] array corresponds to the number of sampling data within the D[i] array.

Step S72, performing square-law detection on all frequency data within the A[i] array, forming several complex number data with every four frequency data, and each complex number data in step S72 consists of a real part and an imaginary part, wherein
the real part is calculated as the quotient of the difference between the first frequency data and the third frequency data among the four frequency data and 2:

$${B}_{j}^{cos} = \frac{{A}_{( 4 j )} - {A}_{( 4 j + 2 )}}{2} ;$$

and
the imaginary part is calculated as the quotient of the difference between the second frequency data and the fourth frequency data among the four frequency data and 2:

$${B}_{j}^{sin} = \frac{{A}_{( 4 j + 1 )} - {A}_{( 4 j + 3 )}}{2} ;$$

where A₍ⱼ₎ represents frequency data, and Bⱼ represents complex number data.

Step S73, calculating a first threshold,
First, converting complex number data into real number data (demodulation), wherein
the real number data is represented as Cⱼ=\sqrt{(Bⱼ^{cos})²+(Bⱼ^{sin})²};
Besides, summing up and calculating an average value, wherein
the average value is represented as

$$C = \frac{1}{J} \sum {C}_{j} ;$$

Then, calculating a mean square deviation C^{σ} based on the real data and the average value,.
   wherein
the mean square deviation is represented as

$${C}^{σ} = \sqrt{\frac{1}{J} {\sum }_{j = 0}^{J - 1} {( {C}_{j} - \overline{C} )}^{2}} ;$$

and
The first threshold is represented as C^{P}=k·C^{σ}, where k=2.

Step S74, comparing all frequency data in the A[i] array with the first threshold, selecting frequency data below the first threshold to form a new set of frequency data. and calculating a second threshold according to steps S72-S73.

Step S75, comparing all frequency data in the A[i] array with the second threshold and counting a number of frequency data above the second threshold.

Step S76, determining whether the count of frequency data is more than 10% of total number of all frequency data in the A[i] array; indicating the detection of impact vibration signals if the count of frequency data above the second threshold is more than 10% of the total number of all frequency data; and indicating that impact vibration signals are not detected if the count of frequency data above the second threshold is not more than 10% of the total number of all frequency data.

If the frequency-domain processing shows no signal detection, select sampling data of a next response period, reassign the sampling data of the next response period to the D[i] array, and return to step S2 to restart operation.

In summary, the process first involves picking up signals through an impact vibration sensor and then selecting and adjusting the effective signal output through time-domain processing. This approach ensures high accuracy and real-time characteristics in the picked-up signals. Furthermore, by applying frequency-domain processing to the picked-up signals, the accuracy and reliability of the signals are further enhanced.

The above is merely a preferred embodiment of the present invention and should not be construed as limiting the invention in any form. Any simple modifications, equivalent changes, or adaptations made to the above embodiments based on the technical essence of the present invention still fall within the scope of the technical solution of the present invention.

What is claimed is:

1. A method for picking up signals from an impact vibration sensor, characterized in that the method comprises the following steps:
step S1, sampling vibration frequency through the impact vibration sensor to obtain several sampling data, and according to a predetermined response period, allocating the sampling data to several response periods, and selecting a response period and proceeding to step S2;
step S2, averaging the sampling data within the response period and identifying a maximum value among sampling data;
step S3, determining whether the maximum value is located in the middle of the sampling data's sampling time, proceeding to step S6 if the maximum value is located in the middle of the sampling data's sampling time, and proceeding to step S4 if the maximum value is not located in the middle of the sampling data's sampling time;
step S4, determining whether the sampling data meets quantity and trend requirements. proceeding to step SS if the sampling data meets the quantity and trend requirements, and selecting sampling data of a next response period and returning to step S2 if the sampling data does not meet the quantity and trend requirements;
step S5, starting with an effective value of a current sampling data, moving the position of the response period, re-obtaining a complete response period, and returning to step S2; and
step S6, determining whether the following three conditions are all met within the response period: sampling data on the left side of the maximum value increases monotonically. sampling data on the right side of the maximum value decreases monotonically, and values of monotonic increase and monotonic decrease are the same; determining the sampling data picked up within the response period meet the requirements if the three conditions are all met, and selecting sampling data of a next response period and returning to step S2 if the three conditions are not all met.

2. The method for picking up signals from an impact vibration sensor according to claim 1, wherein the method for determining whether the sampling data meets the quantity and trend requirements in step S4 comprises:
step S41, searching for and counting a number of sampling data on the left side of the maximum value that are above an average value and determining whether the count of the sampling data on the left side of the maximum value that are above the average value is less than N, proceeding to step S42 if the count is less than N, and proceeding to step S43 if the count is not less than N;
step S42, searching for and counting a number of sampling data on the right side of the maximum value that are above an average value and determining whether the count of the data on the right side of the maximum value that are above the average value is less than N, selecting the sampling data of a next response period and returning to step S2 if the count is less than N, and proceeding to step S44 if the count is not less than N;
step S43, dividing the sampling data on the left side of the maximum value into k parts, adding up the sampling data on the left side of the maximum value in each part to get k sums, and determining whether the k sums increase monotonically; proceeding to step SS if the k sums increase monotonically, and selecting sampling data of a next response period and returning to step S2 if the k sums do not increase monotonically; and
step S44, dividing the sampling data on the right side of the maximum value into k parts, adding up the sampling data on the right side of the maximum value in each part to get k sums, and determining whether the sums decrease monotonically; proceeding to step SS if the k sums decrease monotonically, and selecting sampling data a next response period and returning to step S2 if the k sums do not decrease monotonically.

3. The method for picking up signals from an impact vibration sensor according to claim 2, characterized in that N in steps S41 and S42 is 100.

4. The method for picking up signals from an impact vibration sensor according to claim 1, wherein the method for determining whether sampling data on the left side of the maximum value increases monotonically in step S6 comprises: dividing sampling data within the response period into q parts, adding up the sampling data in each part to obtain q sums, and selecting several sums on the left side of the maximum value for determining.

5. The method for picking up signals from an impact vibration sensor according to claim 1, wherein the method for determining whether sampling data on the right side of the maximum value decreases monotonically in step S6 comprises: dividing sampling data within that response period into q parts, adding up the sampling data in each part to obtain q sums, and selecting several sums on the right side of the maximum value for determining.

6. The method for picking up signals from an impact vibration sensor according to claim 1, characterized in that after completing picking up of impact vibration signal, sampling data are processed using a frequency-domain processing method to determine whether the impact vibration signal is detected.

7. The method for picking up signals from an impact vibration sensor according to claim 6, wherein a frequency-domain processing method comprises:
step S71, performing FFT calculations on all sampling data to obtain several frequency data;
step S72, performing square-law detection on the several frequency data, forming several complex number data with every four frequency data;
step S73, calculating a first threshold by converting the complex number data into real number data, summing them up and calculating an average value, and calculating a mean square deviation C^{σ} based on the real number data and the average value; wherein
the first threshold is represented as C^{P}=k·C^{σ}, where k=2;
step S74, comparing all frequency data with the first threshold, selecting frequency data below the first threshold to form a second set of frequency data, and calculating a second threshold according to steps S72-S73;
step S75, comparing all frequency data with the second threshold and counting a number of frequency data above the second threshold;
S76, determining whether the count of frequency data above the second threshold is more than 10% of total number of all frequency data, indicating that impact vibration signal is detected if the count is more than 10% of the total number of all frequency data. and indicating that impact vibration signal is not detected if the count is not more than 10% of the total number of all frequency data.

8. The method for picking up signals from an impact vibration sensor according to claim 7, characterized in that complex number data in step S72 comprise a real part and an imaginary part, wherein
the real part is represented as:
$${B}_{j}^{cos} = \frac{{A}_{( 4 j )} - {A}_{( 4 j + 2 )}}{2} ;$$
and
the imaginary part is represented as:
$${B}_{j}^{sin} = \frac{{A}_{( 4 j + 1 )} - {A}_{( 4 j + 3 )}}{2} ;$$
where A₍ⱼ₎ represents frequency data, and Bⱼ represents complex number data.

9. The method for picking up signals from an impact vibration sensor according to claim 8, characterized in that a formula for converting complex number data into real number data is as follows:
$${C}_{j} = \sqrt{{( {B}_{j}^{cos} )}^{2} + {( {B}_{j}^{sin} )}^{2}} .$$
